(19) United States
(12) Patent Application Publication
(10) Pub. No.: US 2026/0127800 A1
(43) Pub. Date: May 7, 2026

(54) NEURAL MOTION RIG FOR INTERACTIVE MOTION AUTHORING

(71) Applicants: DISNEY ENTERPRISES, INC., Burbank, CA (US); ETH Zürich (Eidgenössische Technische Hochschule Zürich), Zürich (CH)

(72) Inventors: Martin GUAY, Unterengstringen (CH); Dhruv AGRAWAL, Zürich (CH); Robert Walker SUMNER, Zürich (CH); Jakob Joachim BUHMANN, Zürich (CH); Dominik Tobias BORER, Greifensee (CH)

(21) Appl. No.: 18/936,207

(22) Filed: Nov. 4, 2024

(51) Int. Cl. G06T 13/40; G06T 17/00

(52) U.S. Cl. CPC G06T 13/40; G06T 17/00

(57) ABSTRACT

One embodiment of the present invention sets forth a technique for generating a motion for a virtual character. The technique includes determining a graph representation of a plurality of sets of joints corresponding to a sequence of poses for the virtual character based on (i) one or more input poses for the virtual character and (ii) a set of constraints associated with one or more joints included in the plurality of sets of joints. The technique also includes generating, via execution of a neural network, a set of updated node states for the plurality of sets of joints based on the graph representation. The technique further includes generating, based on the updated node states, the motion that includes (i) a first set of joint positions for the plurality of sets of joints and (ii) a first set of joint orientations for the plurality of sets of joints.

### BACKGROUND

### Field of the Various Embodiments

Embodiments of the present disclosure relate generally to computer vision and machine learning and, more specifically, to a neural motion rig for interactive motion authoring.

### Description of the Related Art

Films, video games, virtual reality (VR) systems, augmented reality (AR) systems, mixed reality (MR) systems, robotics, and/or other types of interactive environments frequently include entities (e.g., characters, robots, etc.) that are posed and/or animated in three-dimensional (3D) space. Traditionally, an entity is posed via a time-consuming, iterative, and laborious process of manually manipulating multiple control handles corresponding to joints (or other parts) of the entity. An inverse kinematics (IK) technique can also be used to compute the positions and orientations of remaining joints (or parts) of the entity that result in the desired configuration of the manipulated joints (or parts). To animate the entity, this manual process is repeated for additional keyframes within a sequence of poses representing movements of the entity, with poses for frames between keyframes generated by interpolating between the keyframes using parametric curves.

More recently, advancements in machine learning and deep learning have led to the development of neural motion completion models, which include deep neural networks that leverage full-body correlations learned from large datasets to predict frames that fall between key frames within an animation. However, conventional neural motion completion models are associated with a number of limitations that interfere with use of the neural motion completion models in animation workflows.

More specifically, conventional neural motion completion models operate using a dense context and/or set of constraints, such as a fully body pose, an upper and/or lower body pose, and/or a complete trajectory for a single joint. Defining this dense context involves significant time and resource overhead that is analogous to traditional techniques for manually defining a pose via control handles. This dense context additionally prevents animators and/or other users from exploring, refining, and/or controlling the motion in a finer-grained manner.

Further, conventional neural motion completion models cannot be used to perform motion editing, in which changes are made to select portions of an existing motion while preserving the remainder of the motion. Instead, these models may disregard existing motion while preserving constraints.

As the foregoing illustrates, what is needed in the art are more effective techniques for performing neural motion completion.

### SUMMARY

One embodiment of the present invention sets forth a technique for generating a motion for a virtual character. The technique includes determining a graph representation of a plurality of sets of joints corresponding to a sequence of poses for the virtual character based on (i) one or more input poses for the virtual character and (ii) a set of constraints associated with one or more joints included in the plurality of sets of joints. The technique also includes generating, via execution of a first neural network, a set of updated node states for the plurality of sets of joints based on the graph representation. The technique further includes generating, based on the set of updated node states, the motion that includes (i) a first set of joint positions for the plurality of sets of joints and (ii) a first set of joint orientations for the plurality of sets of joints.

One technical advantage of the disclosed techniques relative to the prior art is the ability to generate complete motions from sparse poses and joint-level constraints. The disclosed techniques thus reduce time and resource overhead associated with manually defining dense poses and/or constraints in traditional animation workflows and/or as input into conventional neural completion models. The disclosed techniques additionally provide finer-grained control over the generated motions than conventional neural completion models that require dense context and/or constraints on poses within an animation. Another technical advantage of the disclosed techniques is the ability to make select changes to certain portions of a base motion while preserving remaining portions of the base motion. Consequently, the disclosed techniques can be used in motion editing workflows, unlike conventional approaches that disregard existing motion after constraints on the motion are specified. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computing device configured to implement one or more aspects of various embodiments.

FIG. 2 illustrates the operation of the training engine and execution engine of FIG. 1 in performing interactive motion authoring, according to various embodiments.

FIG. 3A illustrates an example architecture for the machine learning model of FIG. 2, according to various embodiments.

FIG. 3B illustrates an example graph representing a sequence of poses corresponding to a motion for a virtual character, according to various embodiments.

FIG. 4A illustrates an example user interface for performing interactive motion authoring, according to various embodiments.

FIG. 4B illustrates an example user interface for performing interactive motion authoring, according to various embodiments.

FIG. 5 is a flow diagram of method steps for generating a motion for a virtual character, according to various embodiments.

FIG. 6 illustrates the operation of the training engine and execution engine of FIG. 1 in performing interactive motion editing, according to various embodiments.

FIG. 7 illustrates the operation of the data-generation component of FIG. 6 in generating a training base motion from a training sequence, according to various embodiments.

FIG. 8A illustrates an example user interface for performing interactive motion editing, according to various embodiments.

FIG. 8B illustrates an example user interface for performing interactive motion editing, according to various embodiments.

FIG. 9 is a flow diagram of method steps for editing a motion for a virtual character, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

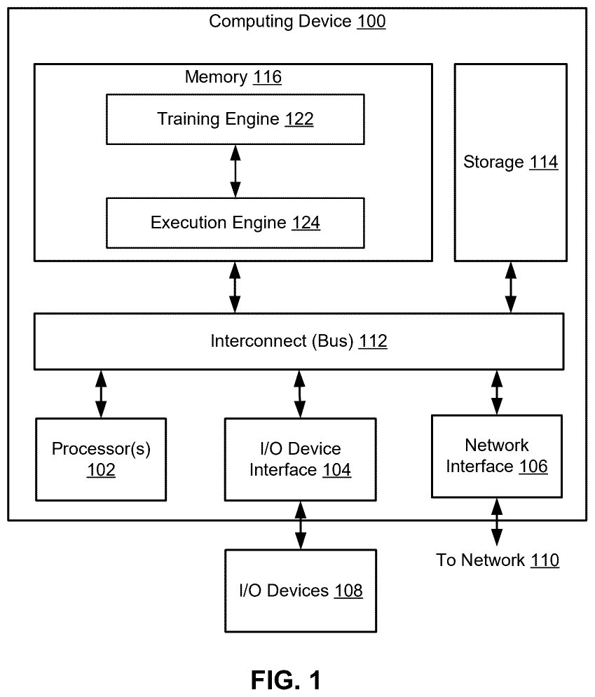

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

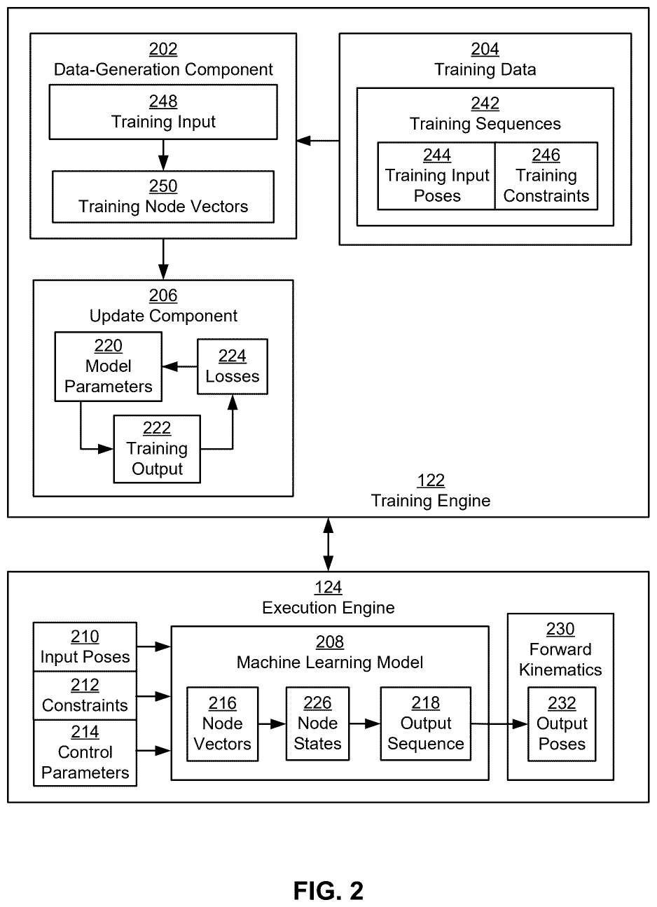

In some embodiments, training engine 122 and execution engine 124 operate to train and execute one or more machine learning models to perform interactive motion authoring and/or motion editing. Each machine learning model generates a motion as a time-varying sequence of poses for an entity in two-dimensional (2D) and/or three-dimensional (3D) space. During motion authoring, the motion generated by a machine learning model is conditioned on a set of sparse constraints (e.g., positions and/or orientations of a subset of joints within the sequence) and/or a set of input poses (e.g., the first and last pose in the sequence). For example, the machine learning model may generate an output sequence of poses that depicts natural motion while satisfying the sparse constraints and/or retaining the input poses. Training and executing a machine learning model to perform interactive motion authoring is described in further detail below with respect to FIGS. 2-5.

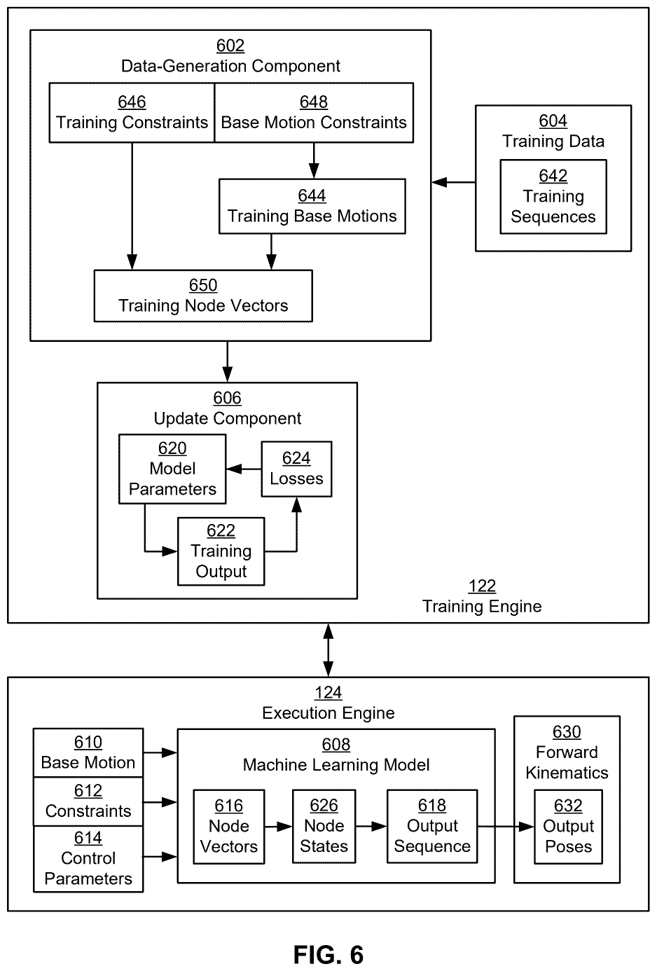

During motion editing, the motion generated by a machine learning model is conditioned on a base motion for the entity (e.g., a preexisting sequence of poses for the entity) and/or a set of sparse constraints. For example, the machine learning model may generate an output sequence of poses that preserves certain aspects of the base motion while satisfying the sparse constraints. Training and executing a machine learning model to perform interactive motion editing is described in further detail below with respect to FIGS. 6-9.

### Neural Motion Rig for Interactive Motion Authoring

FIG. 2 illustrates the operation of training engine 122 and execution engine 124 of FIG. 1 in performing interactive motion authoring, according to various embodiments. For example, training engine 122 and execution engine 124 may use machine learning model 208 to generate an output sequence 218 of multiple output poses 232 corresponding to the motion of a human, animal, robot, and/or another type of articulated object representing a virtual character.

Each of output poses 232 includes a set of two-dimensional (2D) and/or three-dimensional (3D) joint positions, joint orientations, and/or other representations of joints in the articulated object. A skeleton for the articulated object may be defined using a skeleton graph that includes nodes representing joints in the articulated object and spatial edges between pairs of nodes that represent limbs in the articulated object. Additionally, each joint representing a foot (or another part of the articulated object that is capable of contacting the ground) may be associated with a binary ground contact label that is set to 1 when the joint is in contact with the ground and to 0 otherwise.

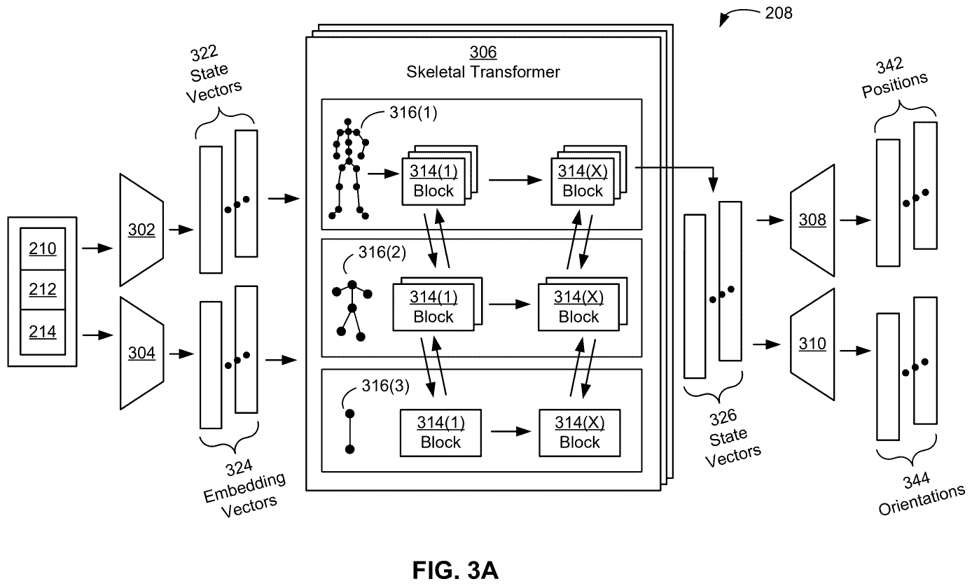

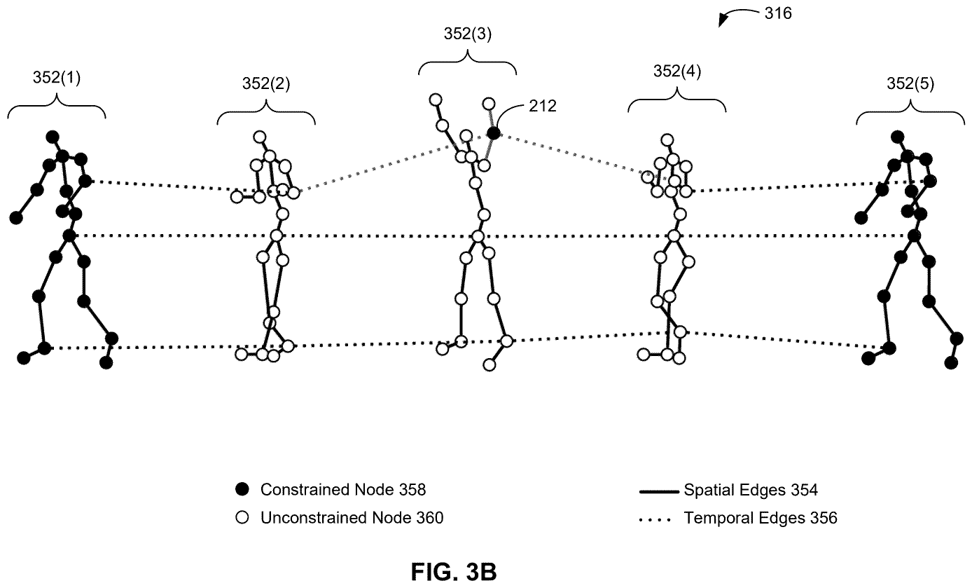

Additionally, the ordering of output poses 232 within output sequence 218 corresponds to a motion for the articulated object. For example, the motion for a given joint in the virtual character may be defined as {x₀, x₁, . . . , x_{T}}, where xₜ∈{pos, rot} corresponds to a global position and orientation of that joint at time step t. A graph representing output sequence 218 may be defined by creating a copy of the skeleton graph for each temporal position (e.g., time step) in output sequence 218 and adding a temporal edge between xₜ and xₜ₋₁ (for t−1≥0) and/or between xₜ and x₊₁ (for t+1≤T) for each joint in the articulated object, as described in further detail below with respect to FIG. 3B. For example, the graph may include a node

$${η}_{t}^{j}$$

for each joint j at each time step t. Thus, for a motion clip with T+1 frames and a skeleton with Nⱼ joints, the total number of nodes is (T+1)×Nⱼ.

As shown in FIG. 2, input into machine leaning model 208 includes one or more input poses 210, a set of constraints 212, and/or a set of control parameters 214. Each of input poses 210 include a set of positions, orientations, and/or other attributes of joints in the virtual character at a corresponding time. For example, each input pose may include a previously defined pose for the virtual character, as specified by an artist, a posing tool, a neural IK model, a motion capture dataset, and/or a frame in an animation that includes the virtual character.

In some embodiments, input poses 210 include a starting pose (e.g., at time t=0) and/or an ending pose (e.g., at time t=T) for the virtual character. Input poses 210 may also, or instead, include one or more intermediate poses (e.g., at one or more times 0<t<T) between the starting pose and ending pose.

Constraints 212 include positions, orientations, ground contact constraints (e.g., values of the ground contact label that indicate whether or not a corresponding joint contacts the ground at a given time), and/or other types of attributes that are not included in input poses 210 but are to be maintained in output poses 232 within output sequence 218. Continuing with the above example, constraints 212 may be specified for a “sparse” subset of joints at times that range from t=1 to t=T−1. Constraints 212 may also, or instead, be specified via user manipulation of control handles for the joint(s) of the virtual character and/or other user-interface elements.

Control parameters 214 include values that are used to control the generation of output poses 232 from input poses 210 and constraints 212. For example, control parameters 214 may include an orientation preservation parameter in the range of [0,1] that specifies the extent to which the orientations of joints in input poses 210 and/or constraints 212 should be preserved. Control parameters 214 may also, or instead, include a position preservation parameter in the range of [0,1] that specifies the extent to which the positions of joints in input poses 210 and/or constraints 212 should be preserved. Values of the orientation preservation parameter and position preservation parameter may be specified for individual joints, sets of joints (e.g., limbs, body segments, upper body, lower body, etc.), all joints in the virtual character, specific points in time in output sequence 218, specific ranges of time in output sequence 218, and/or other groupings of one or more joints in the virtual character and/or one or more nodes in the graph representing output sequence 218.

Given input poses 210, constraints 212, and/or control parameters 214, machine learning model 208 generates output sequence 218 that includes output poses 232 from time t=0 to time t=T. Output poses 232 include positions, orientations, and/or other attributes of joints included in input poses 210 and constraints 212. Output poses 232 additionally include positions, orientations, and/or other attributes of additional joints at times that range from t=1 to t=T−1 that are not included in input poses 210 and constraints 212.

As mentioned above, the influence of input poses 210 and/or constraints 212 on one or more attributes of a given joint in output poses 232 may be determined based on one or more corresponding control parameters 214. Continuing with the above example, a higher value for the orientation preservation parameter may cause the orientations of a corresponding grouping of joints in input poses 210 and/or constraints 212 to exert a greater influence on the orientations of the same joints within output sequence 218. Similarly, a higher value for the position preservation parameter may cause the positions of a corresponding grouping of joints in input poses 210 and/or constraints 212 to exert a greater influence on the positions of the same joints within the output sequence 218.

To generate output sequence 218, machine learning model 208 converts input poses 210, constraints 212, and control parameters 214 into a set of node vectors 216 representing nodes in the graph. Machine learning model 208 uses a set of neural network blocks and/or other components to convert node vectors 216 into multiple sets of node states 226 for the corresponding nodes. Machine learning model 208 then converts a final set of node states 226 into positions and orientations of the nodes within output sequence 218. The operation of machine learning model 208 is described in further detail below with respect to FIG. 3A.

FIG. 3A illustrates an example architecture for machine learning model 208 of FIG. 2, according to various embodiments. As shown in FIG. 3A, machine learning model 208 includes a set of encoders 302 and 304, multiple skeletal transformer 306 layers, and a set of decoders 308 and 310. Each of these components is described in further detail below.

Input into encoders 302 and 304 includes input poses 210, constraints 212, and/or control parameters 214. Given this input, encoders 302 and 304 generate a set of state vectors 322 and a set of embedding vectors 324 included in node vectors 216. More specifically, encoder 302 generates a set of state vectors 322 that represent positions, orientations, and/or other attributes of joints in output sequence 218 based on input poses 210 and constraints 212. For example, encoder 302 may include a fully connected neural network with one hidden layer and/or another type of machine learning architecture. Encoder 302 may generate, for nodes

$${η}_{t}^{j}$$

in the graph representing output sequence 218, a set of state vectors 322 Nodeₛₜₐₜₑ∈ [symbol] . Each state vector has a length of h and encodes a concatenation of the positions, orientations, and ground contact labels for joints represented by the nodes.

Encoder 304 generates a set of embedding vectors 324 that represent identities, input poses 210, constraints 212, and/or control parameters 214 associated with joints in output sequence 218. For example, encoder 304 may include a fully connected neural network with one hidden layer and/or another type of machine learning architecture. Encoder 304 may generate, for each node

$${η}_{t}^{j}$$

in the graph representing output sequence 218, a set of embedding vectors 324 Node_{emb}∈ [symbol] . Each embedding vector may include a linear embedding of a one-hot vector for joint j, a positional encoding for time t, and a mask mask_{*} indicating whether or not the joint is included in input poses 210 and/or constraints 212. The calculation of embedding vectors 324 may be represented by the following:

$${J}_{e m b} = {W}_{e m b} {1}_{A} ( [ 1 , 2 , … , {N}_{j} ] ) ( ∈ ) \qquad ( 1 )$$

$${T}_{e m b} = P E ( [ 1 , 2 , … , T ] ) ( ∈ ) \qquad ( 2 )$$

$${Node}_{e m b} = [ {J}_{e m b} , {T}_{e m b} , {mask}_{*} ] ( ∈ {ℝ}^{T \times {N}_{j} \times h} ) , \qquad ( 3 )$$

In the above equation, W_{emb} is a learned linear transformation, 1_{A} is a one-hot encoding function, PE is a positional encoding, and an expansion along appropriate dimensions is performed in Equation 3 to construct embedding vectors 324.

Next, skeletal transformer 306 layers use state vectors 322 and embedding vectors 324 to iteratively update node states 226 for the joints. As shown in FIG. 3, each skeletal transformer 306 layer uses a series of blocks 314(1)-314(X) (each of which is referred to individually herein as block 314) to exchange information among neighboring joints in the virtual character. Blocks 314(1)-314(X) are additionally used to process information associated with three different graphs 316(1), 316(2), and 316(3) (each of which is referred to individually herein as graph 316). Each graph 316 represents a different resolution associated with the skeletal structure of the virtual character. For example, graph 316(1) may represent a joint-level skeleton with one node per joint. Graph 316(2) may represent a limb-level skeleton that pools joints from graph 316(1) into nodes for the hip, spine, and each of the four limbs. Graph 316(3) may represent a body-level skeleton that further reduces nodes from graph 316(2) into one node each for the upper and lower body. Further, each graph 316 may include multiple copies of the corresponding skeletal structure to represent a time-varying output sequence 218 and temporal edges between pairs of nodes representing the same joint at adjacent temporal positions within output sequence 218.

In one or more embodiments, skeletal transformer 306 includes a graph transformer neural network that uses attention mechanisms in blocks 314 and a number of message-passing steps to exchange information among neighboring joints in each graph 316. The output of a given skeletal transformer 306 layer includes a set of state vectors 326 representing node states 226 of nodes in the corresponding graph 316. These state vectors 326 may be inputted into the next skeletal transformer 306 layer, and the process may be repeated using the next skeletal transformer 306 layer until a set of state vectors 326 representing final node states 226 is outputted by the last skeletal transformer 306 layer.

FIG. 3B illustrates an example graph 316 representing a sequence of poses corresponding to a motion for a virtual character, according to various embodiments. Graph 316 includes five sets of nodes 352(1)-352(5) representing five different poses in the sequence. Nodes 352(1) represent a starting input pose (e.g., at t=0), nodes 352(5) represent an ending input pose (e.g., at t=4), and nodes 352(2)-352(4) represent three sets of poses that fall between the starting input pose and the ending input pose (e.g., at t=1 to t=3).

Each solid node in graph 316 may correspond to a constrained node 358 that includes a prespecified position and/or orientation. As shown in FIG. 3B, all nodes 352(1) and 352(5) corresponding to the starting and ending input poses 210 are constrained nodes. Further, nodes 352(3) include one constrained node 358 that corresponds to a left elbow in the third frame of the sequence. This constrained node 358 may include a position and/or orientation that are specified via user manipulation of control handles for the joint(s) of the virtual character and/or another mechanism.

Each remaining node in graph 316 is not shown in solid and corresponds to an unconstrained node 360. Positions and/or orientations of these unconstrained nodes may be iteratively updated by skeletal transformer 306 in a way that results in natural motion and satisfies constraints associated with the constrained nodes.

In one or more embodiments, the positions and/or orientations of unconstrained nodes in graph 316 are initialized by interpolating between known positions and/or orientations associated with constrained nodes in graph 316. For example, positions of the unconstrained nodes may be initialized by performing linear interpolation on positions of the constrained nodes. Orientations of the unconstrained nodes may be initialized by performing spherical interpolation on orientations of the constrained nodes. This interpolation results in dense initial positions pos∈ [symbol] and orientation rot∈ [symbol] . For nodes representing feet (or other joints that can contact the ground), the ground contact label may be set to 0.5 when the ground contact state is unknown and to 0 otherwise, resulting in contact∈ [symbol] . To inform machine learning model 208 of constrained nodes in graph 316, mask_{*}∈ [symbol] is generated as a concatenation of masks denoting position, orientation, and ground contact constraints (i.e., *∈{pos, rot, contact}).

Within each set of nodes 352(1)-352(5), solid lines between pairs of nodes denote spatial edges 354 that represent limbs formed between the corresponding joints. Dotted lines between pairs of nodes denote temporal edges 356 that represent temporal relationships between the same joints in adjacent poses. Nodes 352(1)-352(5), spatial edges 354, and temporal edges 356 in graph 350 are used by attention mechanisms in skeletal transformer 306 to perform message passing in the spatial and temporal neighborhood of each joint. For example, the constrained node representing the left elbow in the third frame may attend to spatial neighbors of the shoulder and the wrist in the third frame and to temporal neighbors of the elbow in the second and the fourth frame via the attention mechanisms. The process may be repeated for additional graphs 316 representing other resolutions associated with the skeletal structure of the virtual character and/or multiple layers of skeletal transformer 306 prior to generating output sequence 218.

Returning to the discussion of FIG. 3A, in some embodiments, each block 314 includes a skeletal multi-head attention layer, a feedforward neural network, and a residual connection. The skeletal multi-head attention layer splits matrices for queries, keys, and values into multiple sub-matrices. Each sub-matrix of a given matrix is passed through a different attention head to compute an attention score, and multiple attention scores produced by the attention heads in the skeletal multi-head attention are combined into a single attention score. The output of the skeletal multi-head attention for a given node is then calculated as a sum of values for neighboring nodes in a given graph 316 that are weighted by the corresponding attention scores.

When there are no intermediate constraints 212 between the starting and ending input poses 210, information flows from constrained nodes in the starting and ending input poses 210 to unconstrained nodes in poses between the starting and ending input poses 210 due to the local structure of the graph. When intermediate constraints 212 are specified, the propagation of information across poses can be accelerated due to shorter windows with no information.

Because the state of the constrained nodes is provided as input, skeletal transformer 306 layers only update the unconstrained node states to regress the full motion in a latent space. Within a given block 314, embedding vectors 324 are used as keys K and queries Q, and state vectors 322 are used as values V. Therefore, the operation of each skeletal transformer 306 layer i is given by:

$${Node}_{{state}^{′}}^{i} = MHA ( K = Q = {Node}_{emb} , V = {Node}_{state}^{i - 1} ) \qquad ( 4 )$$

$${Node}_{state}^{i} = FCN ( {Node}_{{state}^{′}}^{i} ) + {Node}_{state}^{i - 1} \qquad ( 5 )$$

In the above equations,

$${Node}_{state}^{i}$$

represents state vectors 326 after the i^{th} skeletal transformer 306 layer, MHA denotes the skeletal multi-head attention, and FCN denotes the fully connected network.

Returning to the discussion of FIG. 3A, each skeletal transformer 306 layer uses multiple layers of graphs 316 representing different resolutions associated with the skeletal structure of the virtual character to propagate information across the joints of the virtual character. In particular, skeletal transformer 306 uses a first block 314(1) to perform a first set of message-passing steps that exchange information among nodes in graph 316(1). After the first set of message-passing steps is complete, skeletal transformer 306 uses the output of the first set of message-passing steps and the same block 314(1) to perform a second set of message-passing steps that exchange information among nodes in graph 316(2). After the second set of message-passing steps is complete, skeletal transformer 306 uses the output of the second set of message-passing steps and the same block 314(1) to perform a third set of message-passing steps that exchange information among nodes in graph 316(3). Skeletal transformer 306 additionally uses the output of the third set of message-passing steps and block 314(1) to perform a fourth set of message-passing steps that exchange information among nodes in graph 316(2). Skeletal transformer 306 then uses the output of the fourth set of message-passing steps and block 314(1) to perform a fifth set of message-passing steps that exchange information among nodes in graph 316(1). Skeletal transformer 306 then repeats the process with additional blocks 314 until state vectors 326 representing final node states are outputted by block 314(X).

In some embodiments, blocks 314 and graphs 316 reduce the number of message-passing steps performed to converge on an output sequence 218. For example, skeletal transformer 306 may perform six message-passing steps to exchange information among nodes in graph 316(1), four message-passing steps to exchange information among nodes in graph 316(2), and two message-passing steps to exchange information among nodes in graph 316(3) instead of a much larger number of message-passing steps to exchange information among nodes in a single high-resolution graph (e.g., graph 316(1)).

Skeletal transformer 306 may additionally use various pooling and/or un-pooling functions to mix information between graphs 316 associated with different resolutions. For example, skeletal transformer 306 may use masked inter-level Multi-Head Attention blocks 314 to propagate node states 226 associated with nodes from a given graph 316 to nodes in a different graph 316. The mask associated with these blocks 314 may be designed so that a given node can attend only to itself and corresponding nodes from a different resolution (e.g., one or more nodes in a lower resolution with which the given node is associated, a set of nodes in a higher resolution that are pooled into the given node, etc.). These blocks 314 additionally allow skeletal transformer 306 to dynamically assign weights to information from nodes in different layers.

At the beginning of the message passing process, only constrained joints hold information that should be propagated throughout the skeletal structure. Consequently, skeletal transformer 306 can operate using a node-level mask

$${M}_{k}^{i}$$

that indicates which nodes hold new information in layer i after block k. At the start of the message passing process,

$${M}_{i = 0}^{joint}$$

is the same as mask_{*}, and the limb-level and body-level masks are defined using the following:

$${M}_{t = 0}^{l} [ j ] = \{ \begin{matrix}1 & if ∃ Joint {j}_{0} , s . t . {j}_{0} ∈ j and {c}_{IC}^{{j}_{0}} = 1 \\ 0 & Otherwise\end{matrix} \qquad ( 6 )$$

In other words, a given node in a lower-resolution graph 316 is determined to hold information that should be propagated if the given node is associated with another node in a higher-resolution graph 316 that holds new information.

At the end of every block 314, the mask for layer l∈{joint, limb, body} is updated using the following:

$${M}_{t}^{l} = {A}^{l} {M}_{t - 1}^{l} \qquad ( 7 )$$

In the above equation, A^{l} is the adjacency matrix for nodes in graph 316 of layer l. Each entry in the mask includes an upper bound of 1 that represents full neighbor influence and prevents message passing from increasing for nodes with degree greater than 1.

State vectors 326 outputted by the last skeletal transformer 306 layer are processed by a set of decoders 308 and 310. More specifically, decoder 308 converts state vectors 326 into positions 342 of the corresponding joints in output sequence 218, and decoder 310 converts state vectors 326 into orientations 344 of the corresponding joints in output sequence 218. Like encoders 302 and 304, decoders 308 and 310 may include fully connected networks with one hidden layer and/or other machine learning architectures.

Returning to the discussion of FIG. 2, training engine 122 trains machine learning model 208 using training data 204 that includes a set of training sequences 242. Each training sequence includes a sequence of poses that depicts motion associated with the virtual character. For example, training sequences 242 may depict a person, animal, robot, and/or another type of articulated object walking, jogging, running, turning, spinning, dancing, strafing, waving, climbing, descending, crouching, hopping, jumping, dodging, skipping, interacting with an object, lying down, sitting, stretching, and/or engaging in another type of action, a combination of actions, and/or a sequence of actions. These training sequences 242 may be generated using a motion capture technique. Training sequences 242 may also, or instead, include sequences of poses that are generated and/or edited by artists, animators, and/or other users. Training sequences 242 may also, or instead, be generated synthetically using computer vision, computer graphics, animation, machine learning, and/or other techniques. Poses in training sequences 242 may be retargeted to a skeleton for the virtual character that includes a certain set and/or arrangement of joints.

Each training sequence is associated with a set of training input poses 244 and/or a set of training constraints 246. Like input poses 210, training input poses 244 include various poses associated with the virtual character at certain points in time (e.g., the first and last poses in each training sequence). Like constraints 212, training constraints 246 include positions, orientations, ground contact labels, and/or other types of attributes to be applied to specific joints at specific times within training sequences 242. Training constraints 246 may be user-specified, randomly generated (e.g., by sampling attributes of joints from each training sequence with a certain range of probabilities), and/or otherwise determined.

A data-generation component 202 in training engine 122 converts a given training sequence into a corresponding set of training input 248. For example, data-generation component 202 may generate a graph-based representation (e.g., graph 316 of FIG. 3A) of poses in the training sequence. The graph-based representation may include dense initial positions pos∈ [symbol] , orientations rot∈ [symbol] , ground contact labels contact∈ [symbol] , and masks mask_{*}∈ [symbol] . The initial positions, orientations, and ground contact labels may include values from training constraints 246 for the corresponding nodes and interpolated values for the remaining unconstrained nodes.

Data-generation component 202 also generates a set of training node vectors 250 from each set of training input. Continuing with the above example, data-generation component 202 may use the techniques described above with respect to FIG. 3A to convert the graph-based representation of poses in the training sequence into training node vectors 250 that include per-node state vectors 322 and embedding vectors 324.

An update component 206 in training engine 122 trains machine learning model 208 using training node vectors 250 generated by data-generation component 202 from the corresponding sets of training input 248. More specifically, update component 206 inputs each set of training node vectors 250 into machine learning model 208. Update component 206 also executes machine learning model 208 to produce corresponding training output 222 that represents a predicted motion for the virtual character. Update component 206 computes one or more losses 224 using training output 222 and training sequences 242, training input poses 244, and training constraints 246 used to generate that set of training node vectors 250. Update component 206 then uses a training technique (e.g., gradient descent and backpropagation) to update model parameters 220 of machine learning model 208 in a way that reduces losses 224. Update component 206 repeats the process with additional training node vectors 250 and training output 222 until model parameters 220 converge, losses 224 fall below a threshold, and/or another condition indicating that training of machine learning model 208 is complete is met.

In some embodiments, losses 224 include the following representation:

$$ℒ = {ℒ}_{R} + {ℒ}_{H} + {ℒ}_{C} \qquad ( 8 )$$

In the above equation, [symbol] _{R} denotes a reconstruction loss, [symbol] _{H} denotes a constraint loss, and [symbol] _{C} denotes a ground contact loss.

In some embodiments, the reconstruction loss supervises the predicted local orientations [symbol] , global positions [symbol] , and global orientations [symbol] based on corresponding ground truth values rotₗ, pos_{g}, and rot_{g}, respectively, from training sequences 242. This supervision includes an L² loss that is computed between the predicted positions and corresponding ground truth positions and a geodesic loss that measures the angle on the great arc between a predicted orientation and a corresponding ground truth orientation. The reconstruction loss includes the following formulation:

$$G e o ( R , \hat{R} ) = arc cos [ ( tr ( {\hat{R}}^{T} R ) - 1 ) / 2 ] \qquad ( 9 )$$

$${ℒ}_{pos} = {‖ - {pos}_{g} ‖}_{2} \qquad ( 10 )$$

$${ℒ}_{rot} = G e o ( r o {t}_{l} , ) + G e o ( r o {t}_{g} , ) \qquad ( 11 )$$

$${ℒ}_{R} = {ω}_{p o s} {ℒ}_{p o s} + {ω}_{rot} {ℒ}_{rot} \qquad ( 12 )$$

In the above equations, R and \hat{R} are rotation matrices, and ω_{*} is a scalar control parameter that weights the corresponding loss term according to the amount of the type of ground truth value (e.g., position, orientation, etc.) to be preserved in training output 222.

In one or more embodiments, the constraint loss measures the loss on the constrained positions and orientations associated with training input poses 244 and/or training constraints 246. This can be applied using mask_{*} as follows:

$${ℒ}_{1 K} = {‖ {mask}_{p o s} ⊗ ( - {pos}_{g} ) ‖}_{2} \qquad ( 13 )$$

$${ℒ}_{F K} = {mask}_{rot} ⊗ Geo ( {rot}_{g} , ) \qquad ( 14 )$$

$${ℒ}_{H} = {ω}_{IK} {ℒ}_{IK} + {ω}_{F K} {ℒ}_{F K} \qquad ( 15 )$$

where ⊗ is an element-wise multiplication.

In some embodiments, the ground contact loss supervises the ground contact labels and corresponding foot velocities:

$${ℒ}_{C} = {‖ - contact ‖}_{2} + {‖ ⊗ ‖}_{2} \qquad ( 16 )$$

The above equation includes a first L² norm between the predicted ground contact labels and corresponding ground truth values and a second L² norm of the element-wise product of the predicted ground contact labels and the corresponding predicted velocities [symbol] . Consequently, the ground contact loss aims to minimize the error between the predicted and ground truth ground contact labels while also minimizing the velocities of nodes with predicted ground contact labels that are greater than 0.

After training of machine learning model 208 is complete, execution engine 124 uses the trained machine learning model 208 to generate new output sequences corresponding to motion of the virtual character, where each output sequence 218 is derived from a corresponding set of input poses 210, constraints 212, and/or control parameters 214. For example, execution engine 124 may use a set of encoders in machine learning model 208 to convert a given set of input poses 210, constraints 212, and/or set of control parameters 214 into a corresponding set of node vectors 216. Execution engine 124 may use a graph neural network and/or attention mechanisms in machine learning model 208 to iteratively update a set of node states 226 for joints in the virtual character based on spatial and temporal relationships between nodes represented by node vectors 216 and a hierarchy of resolutions associated with a skeletal structure for the virtual character. Execution engine 124 may then use a set of decoders in machine learning model 208 to convert a final set of node states 226 into a corresponding output sequence 218.

As discussed above, output sequence 218 may maintain attributes of nodes from input poses 210 and constraints 212 based on control parameters 214 that represent the level of influence input poses 210 and/or constraints 212 should have on those attributes. Further, output sequence 218 may include attributes for other unconstrained nodes that result in a natural motion for the virtual character.

After a given output sequence 218 is generated by machine learning model 208, execution engine 124 uses forward kinematics 230 to convert poses within output sequence 218 into final output poses 232 that enforce predefined bone lengths for the virtual character. For example, execution engine 124 may apply forward kinematics 230 to each pose in output sequence 218 as a sequence of rigid transformations that use per-joint offset vectors to update the positions and/or orientations of joints in that pose based on positions and orientations of the joints in a resting pose for the virtual character. Each offset vector may represent a bone length constraint for the corresponding joint and specify a displacement of the joint with respect to a parent joint when the rotation of the joint is zero.

After a final output sequence 218 of output poses 232 is generated, execution engine 124 may generate an animation and/or another representation of the virtual character performing the corresponding motion. For example, execution engine 124 may output a sequence of skeletons, renderings, and/or other visual representations of the virtual character in output poses 232. Execution engine 124 may also, or instead, incorporate output poses 232 into one or more frames of an animation of the virtual character.

In one or more embodiments, values of input poses 210, constraints 212, and control parameters 214 are iteratively updated within a user interface and/or workflow for performing interactive motion authoring associated with the virtual character. For example, an artist, animator, and/or another user may import, into the workflow, one or more “default” poses, manually generated poses, motion capture data, and/or other previously defined poses as an initial set of input poses 210 for the virtual character. The user may also use control handles and/or other user-interface elements to specify constraints 212 on the positions, orientations, and/or other attributes of one or more joints in the virtual character. The user may further specify control parameters 214 that indicate the degree to which joint positions and/or orientations in input poses 210 and/or constraints 212 should be preserved (e.g., due to a lack of relationship between input poses 210 and a target pose to be attained). The user may then trigger the execution of machine learning model 208 within the workflow to generate a corresponding output sequence 218 of output poses 232 that incorporates input poses 210 and constraints 212 into a motion for the virtual character. The user may repeat the process with the generated output poses 232 as new input poses 210 and/or using updated constraints 212. As the generated output sequence 218 of output poses 232 is iteratively refined, the user may update control parameters 214 and/or adjust constraints 212 to reduce the deviation of output poses 232 from input poses 210 and/or constraints 212.

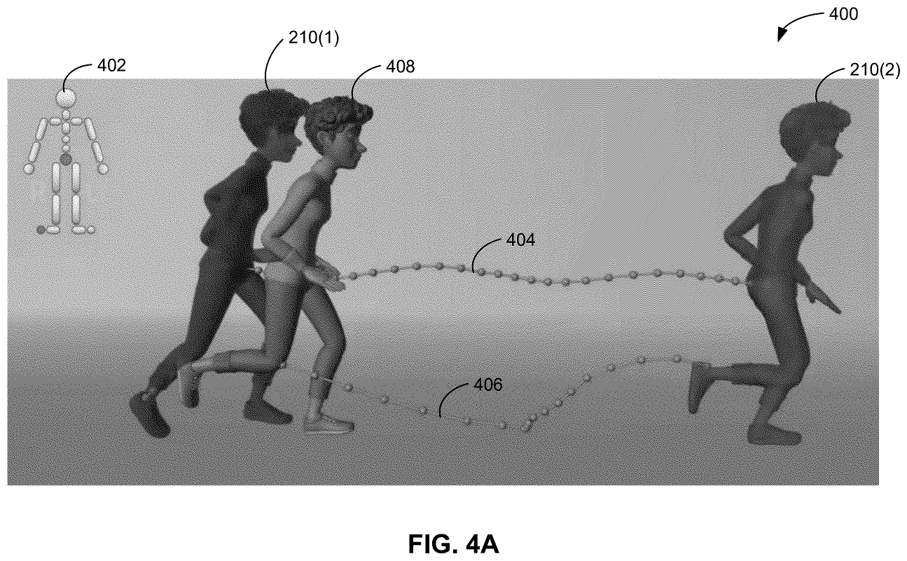

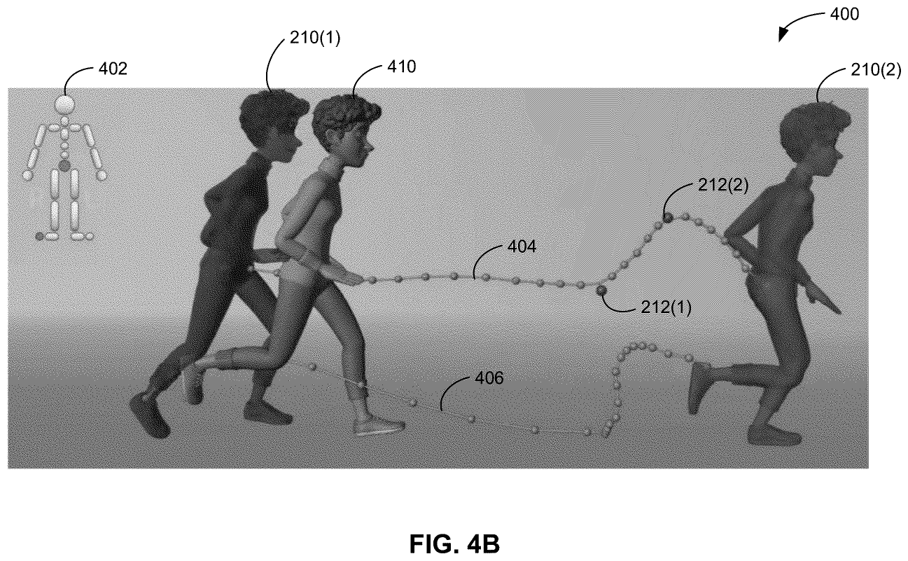

FIG. 4A illustrates an example user interface 400 for performing interactive motion authoring, according to various embodiments. As shown in FIG. 4A, user interface 400 includes two input poses 210(1) and 210(2) that are used to generate a motion for a virtual character. Input pose 210(1) corresponds to a starting pose for the virtual character, and input pose 210(2) corresponds to an ending pose for the virtual character. Input poses 210(1) and 210(2) may be manually defined by a user, generated, selected from motion capture data, and/or otherwise provided (e.g., via user interface 400) as a starting point for generating the motion.

User interface 400 also includes a user-interface element 402 that depicts a skeleton for the virtual character. Within the skeleton, two joints corresponding to the lower torso and right toes have been selected. For example, a user may select the joints by clicking on the positions of the joints within the skeleton and/or otherwise interacting with user-interface element 402.

User interface 400 additionally includes a set of motion curves 404 and 406 corresponding to motions of the selected joints from the starting pose to the ending pose. For example, motion curves 404 and 406 may be outputted within user interface 400 after input poses 210(1) and 210(2) are provided by a user and used by machine learning model 208 to generate a corresponding sequence of output poses 232. Thus, motion curve 404 may correspond to the motion of the selected lower torso joint from input pose 210(1) to input pose 210(2), and motion curve 406 may correspond to the motion of the selected right toes joint input pose 210(1) to input pose 210(2).

User interface 400 further includes a representation 408 of an output pose from the generated sequence. Representation 408 may depict the virtual character at a corresponding point in time within the motion. Representation 408 may additionally be shown within an animation that depicts the virtual character performing the sequence of output poses 232. For example, the animation may include representation 408 and depict the virtual character performing a jogging motion between the starting pose and ending pose.

FIG. 4B illustrates an example user interface 400 for performing interactive motion authoring, according to various embodiments. More specifically, FIG. 4B shows user interface 400 of FIG. 4A after two constraints 212(1) and 212(2) have been added to the motion of the virtual character.

As shown in FIG. 4B, both constraints 212(1) and 212(2) pertain to the lower torso joint of the virtual character. Each constraint 212(1) and 212(2) may be specified by clicking and dragging a corresponding node in motion curve 404 and/or interacting with other portions (not shown) of user interface 400. Each constraint 212(1) and 212(2) may specify a new position, orientation, point in time, and/or another attribute associated with the node.

After a given constraint 212(1) or 212(2) is specified and/or updated, the constraint is inputted into machine learning model 208 with input poses 210(1) and 210(2). In response to the input, machine learning model 208 generates a new sequence of output poses 232. This new sequence is used to generate updated motion curves 404 and 406 and a representation 410 of a new output pose within user interface 400, thereby allowing the user interacting with user interface 400 to visualize the effect of the constraint on the generated motion. In the example of FIG. 4B, constraints 212(1) and 212(2) may be used to add a hop to the jogging motion of the virtual character as the virtual character approaches the ending pose. Constraints 212(1) and 212(2) may continue to be updated and/or new constraints may be added via user interface 400 to further adjust the motion of the virtual character until the motion authoring process is complete.

In one or more embodiments, sequences of poses outputted by machine learning model 208 are used to generate animations, virtual characters, and/or other content in an immersive environment, such as (but not limited to) a VR, AR, and/or MR environment. This content can depict virtual worlds that can be experienced by any number of users synchronously and persistently, while providing continuity of data such as (but not limited to) personal identity, user history, entitlements, possession, and/or payments. It is noted that this content can include a hybrid of traditional audiovisual content and fully immersive VR, AR, and/or MR experiences, such as interactive video.

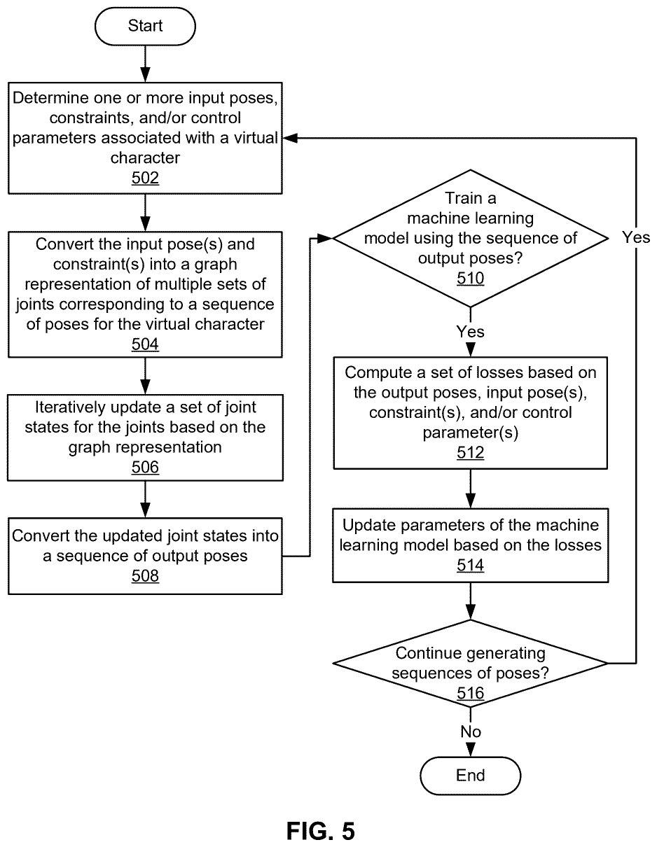

FIG. 5 is a flow diagram of method steps for generating a motion for a virtual character, according to various embodiments. Although the method steps are described in conjunction with the systems of FIGS. 1-2, persons skilled in the art will understand that any system configured to perform the method steps in any order falls within the scope of the present disclosure.

As shown, in step 502, training engine 122 and/or execution engine 124 determine one or more input poses, constraints, and/or control parameters associated with a virtual character. For example, training engine 122 and/or execution engine 124 may receive the input pose(s) as a starting pose and/or ending pose for the virtual character. Training engine 122 and/or execution engine 124 may also obtain constraints related to positions, orientations, and/or ground contact labels for individual joints in the virtual character at specific times within a motion to be generated for the virtual character (e.g., as user input associated with motion curves corresponding to the base motion that are displayed via a user interface). Training engine 122 and/or execution engine 124 may additionally select and/or receive the control parameters as values that indicate the extent to which the position and/or orientation of joints in the input pose(s) and/or constraint(s) should be preserved.

In step 504, training engine 122 and/or execution engine 124 convert the input pose(s) and constraint(s) into a graph representation of multiple sets of joints corresponding to a sequence of poses for the virtual character. For example, the graph representation may include nodes that represent different joints in the virtual character at different temporal positions (e.g., time steps) within the sequence. The graph representation may also include spatial edges between pairs of nodes that correspond to limbs of the character at each temporal position. The graph representation may further include temporal edges between nodes representing the same joint at adjacent temporal positions within the motion. Training engine 122 and/or execution engine 124 may use one or more encoder neural networks to generate, for each node in the graph representation, a node embedding that encodes a joint identifier for the joint, a temporal position of the joint within the sequence of poses, and a set of masks that indicate whether or not the joint is constrained. Training engine 122 and/or execution engine 124 may also use the encoder neural network(s) to generate, for each node in the graph representation, an initial joint state that encodes the position, orientation, ground contact state, and/or other attributes of the corresponding joint at the corresponding time. The positions, orientations, and ground contact labels may include values from nodes associated with the input pose(s) and/or constraints and interpolated values for the remaining nodes.

In step 506, training engine 122 and/or execution engine 124 iteratively update a set of node states for the joints based on the graph representation. For example, training engine 122 and/or execution engine 124 may use a graph transformer neural network to perform message passing among the nodes in the graph representation and/or between the nodes and one or more lower-resolution representations of the skeletal structure of the virtual character. Each message-passing step may involve using a block in the graph transformer neural network to update the node states based on attention scores and/or node states from a previous message-passing step.

In step 508, training engine 122 and/or execution engine 124 convert the updated node states into a sequence of output poses. Continuing with the above example, training engine 122 and/or execution engine 124 may use one or more decoder neural networks to decode final node states outputted by the graph transformer neural network into positions and orientations of the joints at various temporal positions within the sequence. Training engine 122 and/or execution engine 124 may additionally perform a forward kinematics step that updates the positions and/or orientations of the joints in a way that enforces bone lengths in the virtual character. Training engine 122 and/or execution engine 124 may further output a set of motion curves and/or another visualization of the sequence of output poses within a user interface.

In step 510, training engine 122 and/or execution engine 124 determine whether or not to train a machine learning model using the sequence of output poses. For example, training engine 122 and/or execution engine 124 may determine that the encoder, graph transformer, and/or decoder neural networks are to be trained using the sequence of output poses if the sequence is generated during a training process associated with the encoder, graph transformer, and/or decoder neural networks; the sequence is flagged as unnatural, unrealistic, and/or otherwise suboptimal by a user, and/or another condition associated with training of the encoder, graph transformer, and/or decoder neural networks is met.

If training engine 122 and/or execution engine 124 determine that the machine learning model is to be trained using the sequence of output poses, training engine 122 performs step 512, in which training engine 122 computes a set of losses based on the output poses, input pose(s), and/or constraint(s). These losses may include a reconstruction loss between positions and orientations of joints in the output poses and corresponding ground truth positions and orientations in a training sequence. These losses may also, or instead, include a constraint loss between positions and orientations of joints in the output poses that are associated with the input pose(s) and constraint(s) and corresponding values in the input pose(s) and constraint(s). These losses may also, or instead, include a ground contact loss that minimizes the error between predicted and ground truth ground contact labels for certain joints while also minimizing the velocities of joints with predicted ground contact labels that are greater than 0.

In step 514, training engine 122 updates parameters of the machine learning model based on the losses. For example, training engine 122 could use a training technique (e.g., gradient descent and backpropagation) to update neural network weights of the encoder, graph transformer, and/or decoder neural networks in a way that reduces the loss(es).

If training engine 122 and/or execution engine 124 determine in step 510 that the output pose should not be used to train the machine learning model, training engine 122 and/or execution engine 124 skip steps 512 and 514 and proceed to step 516 from step 510.

In step 516, training engine 122 and/or execution engine 124 determine whether or not to continue generating sequences of poses. For example, training engine 122 and/or execution engine 124 may determine that sequences of poses should continue to be generated during training of the machine learning model, during execution of a motion authoring workflow for the virtual character, and/or in another environment or setting in which poses for the virtual character are to be generated. If training engine 122 and/or execution engine 124 determine that sequences of poses should continue to be generated for the virtual character, training engine 122 and/or execution engine 124 repeat steps 502, 504, 506, 508, 510, 512, and/or 514 to continue generating new sequences of output poses for the virtual character and/or training the virtual character using the new sequences of output poses. Training engine 122 and/or execution engine 124 also repeat step 516 to determine whether or not to continue generating sequences of output poses. During step 516, training engine 122 and/or execution engine 124 may determine that sequences of output poses should not continue to be generated once training of the machine learning model is complete, execution of the motion authoring workflow for the virtual character is discontinued, and/or another condition is met.

### Neural Motion Rig for Interactive Motion Authoring

FIG. 6 illustrates the operation of training engine 122 and execution engine 124 of FIG. 1 in performing interactive motion editing, according to various embodiments. Unlike training engine 122 and execution engine 124 of FIG. 2, training engine 122 and execution engine 124 use a machine learning model 608 to generate an output sequence 618 of multiple output poses 232 corresponding to an edited motion of a virtual character. For example, training engine 122 and execution engine 124 may use machine learning model 608 to generate an output sequence 618 of multiple output poses 632 that reflect changes made to a base motion 610 of a human, animal, robot, and/or another type of articulated object representing a virtual character.

As with output poses 232 of FIG. 2, each of output poses 632 includes a set of two-dimensional (2D) and/or three-dimensional (3D) joint positions, joint orientations, and/or other representations of joints in the articulated object. A skeleton for the articulated object may be defined using a graph that includes nodes representing joints in the articulated object and spatial edges between pairs of nodes that represent limbs in the articulated object. Additionally, each joint representing a foot (or another part of the articulated object that is capable of contacting the ground) may be associated with a binary ground contact label that is set to 1 when the joint is in contact with the ground and to 0 otherwise.

The ordering of output poses 632 within output sequence 618 corresponds to a motion for the articulated object. For example, the motion for a given joint in the virtual character may be defined as {x₀, x₁, . . . , x_{T}}, where xₜ∈{pos, rot} corresponds to a global position and orientation of that joint at time t. A graph representing output sequence 218 may be defined by creating a copy of the graph of the skeleton for the articulated object for each time included in output sequence 618 and a temporal edge between xₜ and xₜ₋₁ (for t−1>0) and/or between xₜ and xₜ₊₁ (for t+1≤T) for each joint in the articulated object, as described in further detail below with respect to FIG. 3B. For example, the graph may include a node

$${η}_{t}^{j}$$

for each joint j at each time t. Thus, for a motion clip with T frames and a skeleton with Nⱼ joints, the total number of nodes is T×Nⱼ.

To perform motion editing, base motion 610, a set of constraints 612, and/or a set of control parameters 614 are inputted into machine learning model 608. Base motion 610 includes a sequence of poses that is used as a starting point for producing an edited motion corresponding to output sequence 618. For example, base motion 610 may include the same number of poses and/or temporal positions as output sequence 618. Poses in base motion 610 may be generated using a motion capture technique; by artists, animators, and/or other users; and/or using computer vision, computer graphics, animation, machine learning, and/or other techniques.

Constraints 612 include changes to positions, orientations, ground contact constraints (e.g., values of the ground contact label that indicate whether or not a joint contacts the ground at a given time), and/or other types of attributes of nodes in base motion 610. For example, constraints 612 may be specified for any node in the sequence of poses corresponding to base motion 610. Constraints 612 may also, or instead, be specified via user manipulation of control handles for the joint(s) of the virtual character and/or other user-interface elements.

Control parameters 614 include values that are used to control the generation of output pose 622 from base motion 610 and constraints 612. For example, control parameters 614 may include an orientation preservation parameter in the range of [0,1] that specifies the extent to which the orientations of joints in base motion 610 should be preserved. Control parameters 614 may also, or instead, include a position preservation parameter in the range of [0,1] that specifies the extent to which the positions of joints in base motion 610 should be preserved. Values of the orientation preservation parameter and position preservation parameter may be specified for individual joints, sets of joints (e.g., limbs, body segments, upper body, lower body, etc.), all joints in the virtual character, specific points in time in output sequence 618, specific ranges of time in output sequence 618, and/or other groupings of one or more nodes in the graph.

Given base motion 610, constraints 612, and/or control parameters 614, machine learning model 608 generates output sequence 618 that includes output poses 232 from time t=0 to time t=T. Output poses 632 include positions, orientations, and/or other attributes of joints included in base motion 610. Output poses 632 additionally include positions, orientations, and/or other attributes of joints that are specified in constraints 612.

As mentioned above, the influence of base motion 610 and/or constraints 212 on one or more attributes of a given joint in output poses 632 is determined based on one or more corresponding control parameters 614. Continuing with the above example, a higher value for a given orientation preservation parameter may cause the orientations of a corresponding grouping of joints in base motion 610 and/or constraints 612 to exert a greater influence on the orientations of the same joints within output sequence 618. Similarly, a higher value for a given position preservation parameter may cause the positions of a corresponding grouping of joints in base motion 610 to exert a greater influence on the positions of the same joints within the output sequence 618. In both instances, a greater influence of base motion 610 and/or constraints 612 on the output sequence 618 may cause one or more joints in the output sequence 618 to deviate from the corresponding constraints 612.

To generate output sequence 618, machine learning model 608 converts base motion 610, constraints 612, and/or control parameters 614 into a set of node vectors 616 representing nodes in the graph. Machine learning model 608 uses a set of neural network blocks and/or other components to convert node vectors 616 into multiple sets of node states 626 for the corresponding nodes. Machine learning model 208 then converts a final set of node states 626 into positions and orientations of the nodes within output sequence 618. For example, machine learning model 208 may use the graph representation, neural network components, and/or techniques described above with respect to FIGS. 3A-3B to generate output sequence 618 from base motion 610, constraints 612, and/or control parameters 614.

Training engine 122 trains machine learning model 608 using training data 204 that includes a set of training sequences 642. Each training sequence includes a sequence of poses that depicts a “ground truth” motion associated with the virtual character.

A data-generation component 602 in training engine 122 generates training base motions 644 that are paired with training sequences 642. More specifically, data-generation component 602 samples a set of training constraints 646 from a given training sequence 642. For example, data-generation component 602 may generate training constraints 646 by sampling attributes of joints from the training sequence with a certain range of probabilities. Like constraints 612, training constraints 646 include positions, orientations, ground contact labels, and/or other types of attributes to be applied to specific joints at specific times within training sequences 642.

Data-generation component 602 also samples a different set of base motion constraints 648 from a given training sequence 642. For example, data-generation component 602 may generate base motion constraints 648 by sampling attributes of joints from the training sequence with a certain range of probabilities, which may be the same as or differ from the range of probabilities used to sample training constraints 646.

Data-generation component 602 uses base motion constraints 648 sampled from training sequences 642 to generate corresponding training base motions 644. For example, data-generation component 602 may input base motion constraints 648 associated with a given training sequence into machine learning model 208 of FIG. 2. In response to the inputted base motion constraints 648, machine learning model 208 may generate a realistic training base motion that includes a subset of the high-frequency details of the training sequence. Data-generation component 602 may also, or instead, use interpolation techniques, other machine learning models, and/or other types of techniques to convert base motion constraints 648 into training base motions 644.

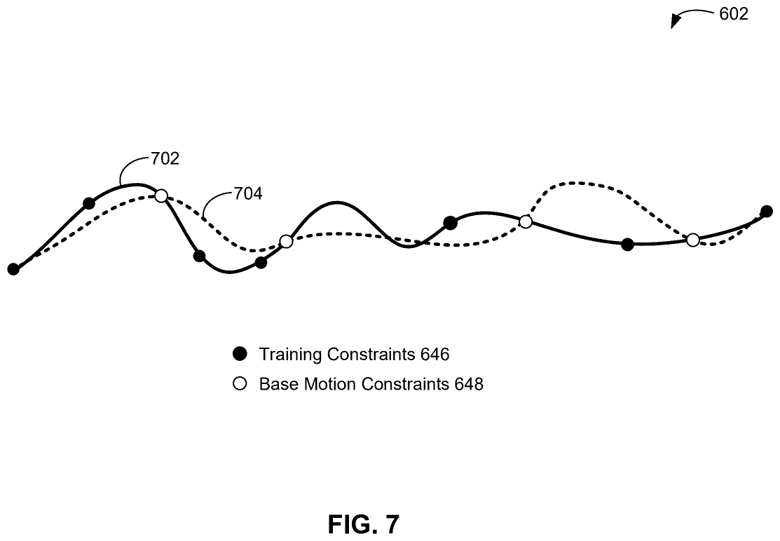

FIG. 7 illustrates the operation of data-generation component 602 of FIG. 6 in generating a training base motion from a training sequence 702, according to various embodiments. Data-generation component 602 samples a set of training constraints 646 (shown as black dots in FIG. 7) from training sequence 702 (shown as a solid line in FIG. 7). Data-generation component 602 also samples a different set of base motion constraints 648 (shown as white dots in FIG. 7) from training sequence 702. The first and last pose in the training sequence are included in both training constraints 646 and base motion constraints 648.

Data-generation component 602 uses machine learning model 208 and/or another technique to generate a training base motion 704 (shown as a dotted line in FIG. 7) from the sampled base motion constraints 648. Training base motion 704 thus includes realistic motion and a higher similarity to training sequence 702 than a randomly generated base motion. Training sequence 702 can additionally be viewed as an “edited” version of the generated training base motion 704 that is produced by applying training constraints 646 to training base motion 704.

Returning to the discussion of FIG. 6, data-generation component 602 generates a set of training node vectors 650 from training constraints 646 and training base motions 644. For example, data-generation component 602 may generate a graph-based representation (e.g., graph 316 of FIG. 3A) of poses in each training base motion. Data-generation component 602 may also overwrite positions, orientations, and/or other attributes of one or more nodes in the graph-based representation with corresponding positions, orientations, and/or other attributes specified in a corresponding set of training constraints 646. Data-generation component 602 may use the techniques described above with respect to FIG. 3A to convert the graph-based representation into training node vectors 650 that include per-node state vectors 322 and embedding vectors 324.

An update component 606 in training engine 122 trains machine learning model 608 using training node vectors 650 generated by data-generation component 602 from the corresponding sets of training constraints 646 and training base motions 644. More specifically, update component 206 inputs each set of training node vectors 650 into machine learning model 608. Update component 606 also executes machine learning model 608 to produce corresponding training output 622 that represents a predicted motion for the virtual character. Update component 606 computes one or more losses 624 using training output 622 and training sequences 642, training base motions 644, and training constraints 646 used to generate that set of training node vectors 650. Update component 606 then uses a training technique (e.g., gradient descent and backpropagation) to update model parameters 620 of machine learning model 608 in a way that reduces losses 624. Update component 606 repeats the process with additional training node vectors 650 and training output 622 until model parameters 620 converge, losses 624 fall below a threshold, and/or another condition indicating that training of machine learning model 608 is complete is met.

In some embodiments, losses 624 include the following representation:

$${ℒ}_{M E} = {ℒ}_{R} + {ℒ}_{H} + {ℒ}_{C} + {ω}_{B M} {ℒ}_{B M} \qquad ( 17 )$$

In the above equation, [symbol] _{BM} is a base motion preservation loss that is computed using the following:

$${ℒ}_{B M} = {‖ {ω}_{M E} ⊗ ( p o {s}_{M E} - p o {s}_{S B} ) ‖}_{2} + Ge o ( {ω}_{M E} ⊗ r o {t}_{M E} , {ω}_{M E} ⊗ r o {t}_{S B} ) \qquad ( 18 )$$

More specifically, pos_{ME} and rot_{ME} are predicted world space positions and orientations generated by machine learning model 608, and posse and rots are the positions and orientations from a corresponding training base motion.

In Equation 18, ω_{ME} is a control parameter that is applied as a weight mask to nodes in temporal positions associated with constraints. For example, ω_{ME} may be generated as a frame-wise weighting. During this frame-wise weighting, a mask m is initially set to 1 for each temporal position that includes at least one constraint and to 0 otherwise. An average filter is then applied over m with a kernel window of a certain size, so that nodes with temporal positions that are closer to constraints are penalized less for not matching the training base motion.

In Equation 17, ω_{BM} is a control parameter that specifies the relative weight of the base motion preservation loss with respect to the reconstruction loss, constraint loss, and ground contact loss. By tuning the kernel window associated with ω_{ME} and ω_{BM}, machine learning model 608 can be trained to preserve base motion more strongly or to satisfy constraints better.

After training of machine learning model 608 is complete, execution engine 124 uses the trained machine learning model 608 to generate new output sequences corresponding to motion of the virtual character, where each output sequence 618 is derived from a corresponding base motion 610, set of constraints 612, and/or control parameters 614. For example, execution engine 124 may use a set of encoders in machine learning model 608 to convert a given base motion 610, set of constraints 612, and/or set of control parameters 614 into a corresponding set of node vectors 616. Execution engine 124 may use a graph neural network and/or attention mechanisms in machine learning model 608 to iteratively update a set of node states 626 for joints in the virtual character based on node vectors 616 and a hierarchy of resolutions associated with a skeletal structure for the virtual character. Execution engine 124 may then use a set of decoders in machine learning model 608 to convert a final set of node states 626 into a corresponding output sequence 618. As discussed above, output sequence 618 may maintain attributes of nodes from base motion 610 and constraints 612 based on control parameters 214 that represent the level of influence base motion 610 and/or constraints 612 should have on those attributes.

After a given output sequence 618 is generated by machine learning model 208, execution engine 124 uses forward kinematics 630 to convert poses within output sequence 218 into a final output sequence 618 of output poses 632 that enforce predefined bone lengths for the virtual character. After the final output sequence 618 of output poses 232 is generated, execution engine 124 may generate an animation and/or another representation of the virtual character performing the corresponding motion. Execution engine 124 may also, or instead, incorporate the generated motion into a user interface and/or workflow for performing motion editing for the virtual character.

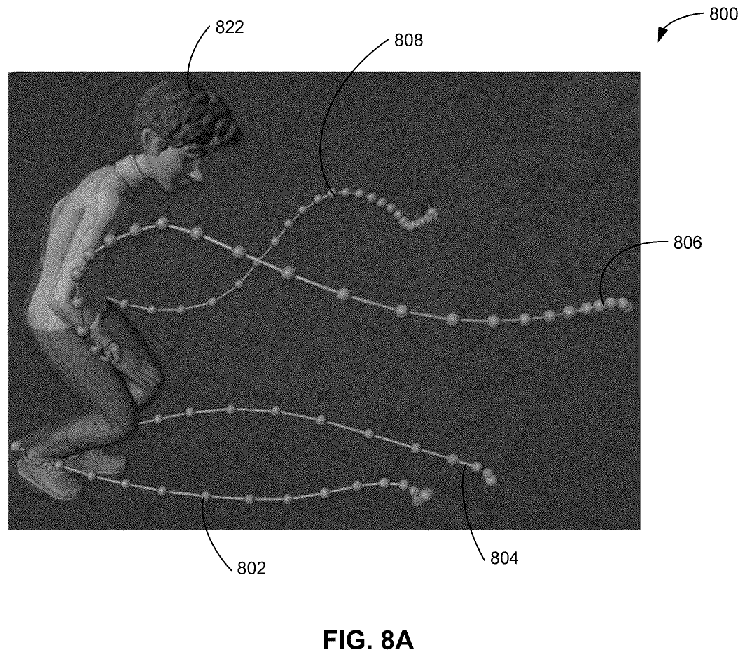

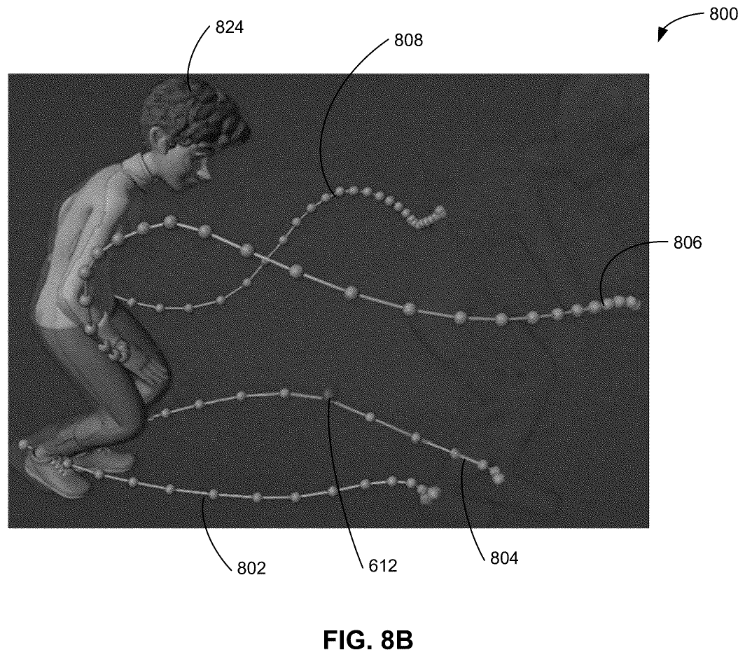

FIG. 8A illustrates an example user interface 800 for performing interactive motion editing, according to various embodiments. As shown in FIG. 8A, user interface 800 includes four motion curves 802, 804, 806, and 808 that correspond to base motion 610 for a virtual character. For example, motion curves 404 and 406 may be outputted within user interface 800 as a representation of base motion 610 and/or a reconstruction of base motion 610 by machine learning model 608 (e.g., in the absence of any constraints 612). Motion curve 802 may depict the motion of the right foot in the virtual character, motion curve 804 may depict the motion of the left foot in the virtual character, motion curve 806 may depict the motion of the right arm in the virtual character, and motion curve 808 may depict the motion of the left arm in the virtual character.

User interface 800 further includes a representation 822 of an output pose associated with base motion 610. Because no constraints 612 have been specified, representation 822 may depict the virtual character at a corresponding point in time within base motion 610. Representation 822 may additionally be shown during an animation that depicts the virtual character performing base motion 610. For example, representation 822 may be included in an animation of the virtual character taking a long step with the right foot, followed by a similar step with the left foot.

FIG. 8B illustrates an example user interface 800 for performing interactive motion authoring, according to various embodiments. More specifically, FIG. 4B shows user interface 800 of FIG. 8A after a set of constraints 612 have been added to the motion of the virtual character.

As shown in FIG. 8B, constraints 612 pertain to a node representing the left foot of the virtual character at a certain point in time. Each constraint may be specified by clicking and dragging a corresponding node in motion curve 804 and/or interacting with other portions (not shown) of user interface 800 to specify a new position, orientation, point in time, and/or another attribute associated with the node.

After constraints 612 have been specified and/or updated, constraints 612 are inputted into machine learning model 608 with base motion 610. In response to the input, machine learning model 208 generates a new sequence of output poses 632 and a new representation 824 of the virtual character. This new sequence is used to update motion curves 802, 804, 806, and 808, thereby allowing the user interacting with user interface 800 to visualize the effect of constraints 612 on the generated motion. In the example of FIG. 8B, constraint 612 may be used to change the height of the step made using the left foot of the virtual character. Further, while motion curve 804 has been updated to incorporate constraints 612 into the motion of the left foot, motion curves 802, 806, and 808 remain relatively unchanged after constraints 612 have been applied, thereby indicating that significant portions of base motion 610 have been preserved. Constraints 612 may continue to be added and/or updated via user interface 800 to further edit the motion of the virtual character until the motion editing process is complete.

In one or more embodiments, sequences of poses outputted by machine learning model 608 are used to generate animations, virtual characters, and/or other content in an immersive environment, such as (but not limited to) a VR, AR, and/or MR environment. This content can depict virtual worlds that can be experienced by any number of users synchronously and persistently, while providing continuity of data such as (but not limited to) personal identity, user history, entitlements, possession, and/or payments. It is noted that this content can include a hybrid of traditional audiovisual content and fully immersive VR, AR, and/or MR experiences, such as interactive video.

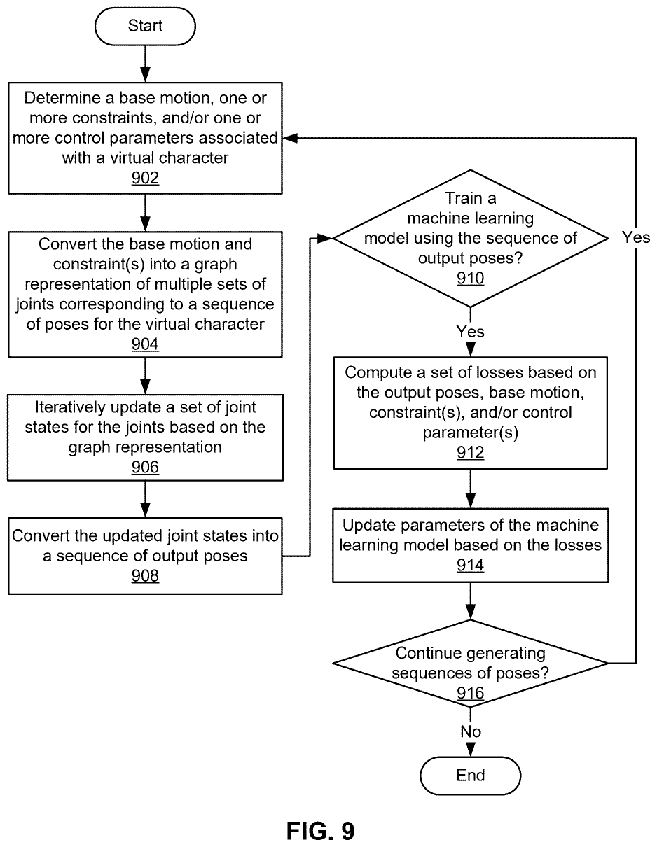

FIG. 9 is a flow diagram of method steps for editing a motion for a virtual character, according to various embodiments. Although the method steps are described in conjunction with the systems of FIGS. 1-2, persons skilled in the art will understand that any system configured to perform the method steps in any order falls within the scope of the present disclosure.

As shown, in step 902, training engine 122 and/or execution engine 124 determine a base motion, one or more constraints, and/or one or more control parameters associated with a virtual character. For example, training engine 122 and/or execution engine 124 may receive the base motion as a “default” motion for the virtual character. Training engine 122 and/or execution engine 124 may also obtain constraints related to the positions, orientations, and/or ground contact labels for individual joints in the virtual character at specific times within the base motion (e.g., as user input associated with motion curves corresponding to the base motion that are displayed via a user interface). Training engine 122 and/or execution engine 124 may additionally select and/or receive the control parameters as values that indicate the extent to which the position and/or orientation of joints in the base motion and/or constraint(s) should be preserved.

In step 904, training engine 122 and/or execution engine 124 convert the base motion and constraint(s) into a graph representation of multiple sets of joints corresponding to a sequence of poses for the virtual character. For example, the graph representation may include nodes that represent different joints in the virtual character at different temporal positions (e.g., time steps) within the sequence. The graph representation may also include spatial edges between pairs of nodes that correspond to limbs of the character at each time. The graph representation may further include temporal edges between nodes representing the same joint at adjacent temporal positions within the motion. Training engine 122 and/or execution engine 124 may use one or more encoder neural networks to generate, for each node in the graph representation, a node embedding that encodes a joint identifier for the joint, a temporal position of the joint within the sequence of poses, and a set of masks that indicate whether or not the joint is constrained. Training engine 122 and/or execution engine 124 may also use the encoder neural network(s) to generate, for each node in the graph representation, an initial joint state that encodes the position, orientation, ground contact state, and/or other attributes of the corresponding joint at the corresponding time. The positions, orientations, and ground contact labels may include values from nodes associated with the input pose(s) and/or constraints and interpolated values for the remaining nodes.

In step 906, training engine 122 and/or execution engine 124 iteratively update a set of node states for the joints based on the graph representation. For example, training engine 122 and/or execution engine 124 may use a graph transformer neural network to perform message passing among the nodes in the graph representation and/or between the nodes and one or more lower-resolution representations of the skeletal structure of the virtual character. Each message-passing step may involve using a block in the graph transformer neural network to update the node states based on attention scores and/or node states from a previous message-passing step.

In step 908, training engine 122 and/or execution engine 124 convert the updated node states into a sequence of output poses. Continuing with the above example, training engine 122 and/or execution engine 124 may use one or more decoder neural networks to decode final node states outputted by the graph transformer neural network into positions and orientations of the joints at various temporal positions within the sequence. Training engine 122 and/or execution engine 124 may additionally perform a forward kinematics step that updates the positions and/or orientations of the joints in a way that enforces bone lengths in the virtual character. Training engine 122 and/or execution engine 124 may further output a set of motion curves and/or another visualization of the sequence of output poses within a user interface.

In step 910, training engine 122 and/or execution engine 124 determine whether or not to train a machine learning model using the sequence of output poses. For example, training engine 122 and/or execution engine 124 may determine that the encoder, graph transformer, and/or decoder neural networks are to be trained using the sequence of output poses if the sequence is generated during a training process associated with the encoder, graph transformer, and/or decoder neural networks; the sequence is flagged as unnatural, unrealistic, and/or otherwise suboptimal by a user, and/or another condition associated with training of the encoder, graph transformer, and/or decoder neural networks is met.

If training engine 122 and/or execution engine 124 determine that the machine learning model is to be trained using the sequence of output poses, training engine 122 performs step 912, in which training engine 122 computes a set of losses based on the output poses, input pose(s), and/or constraint(s). These losses may include a reconstruction loss between positions and orientations of joints in the output poses and corresponding ground truth positions and orientations in a training sequence. These losses may also, or instead, include a constraint loss between positions and orientations of joints in the output poses that are associated with the input pose(s) and constraint(s) and corresponding values in the input pose(s) and constraint(s). These losses may also, or instead, include a ground contact loss that minimizes the error between predicted and ground truth ground contact labels for certain joints while also minimizing the velocities of joints with predicted ground contact labels that are greater than 0. These losses may also, or instead, include a base motion preservation loss between positions and orientations of joints in the output poses and corresponding values in the base motion.

In step 914, training engine 122 updates parameters of the machine learning model based on the losses. For example, training engine 122 could use a training technique (e.g., gradient descent and backpropagation) to update neural network weights of the encoder, graph transformer, and/or decoder neural networks in a way that reduces the loss(es).

If training engine 122 and/or execution engine 124 determine in step 910 that the output pose should not be used to train the machine learning model, training engine 122 and/or execution engine 124 skip steps 912 and 914 and proceed to step 916 from step 910.

In step 916, training engine 122 and/or execution engine 124 determine whether or not to continue generating sequences of poses. For example, training engine 122 and/or execution engine 124 may determine that sequences of poses should continue to be generated during training of the machine learning model, during execution of a motion editing workflow for the virtual character, and/or in another environment or setting in which poses and/or motions for the virtual character are to be generated. If training engine 122 and/or execution engine 124 determine that sequences of poses should continue to be generated for the virtual character, training engine 122 and/or execution engine 124 repeat steps 902, 904, 906, 908, 910, 912, and/or 914 to continue generating new sequences of output poses for the virtual character and/or training the virtual character using the new sequences of output poses. Training engine 122 and/or execution engine 124 also repeat step 916 to determine whether or not to continue generating sequences of output poses. During step 916, training engine 122 and/or execution engine 124 may determine that sequences of output poses should not continue to be generated once training of the machine learning model is complete, execution of the motion editing workflow is discontinued, and/or another condition is met.

In sum, the disclosed techniques perform interactive motion authoring and/or editing using a machine learning model that generates a sequence of poses for an entity in two-dimensional (2D) and/or three-dimensional (3D) space. During motion authoring, the motion generated by the machine learning model is conditioned on a set of sparse constraints (e.g., positions and/or orientations of a subset of joints within the sequence) and/or a set of input poses (e.g., the first and last pose in the sequence). For example, the machine learning model may generate an output sequence of poses that depicts natural motion while satisfying the sparse constraints and/or retaining the input poses.

During motion editing, the motion generated by a machine learning model is conditioned on a base motion for the entity (e.g., a preexisting sequence of poses for the entity) and a set of sparse constraints. For example, the machine learning model may generate an output sequence of poses that preserves certain aspects of the base motion while satisfying the sparse constraints.

The machine learning model includes a set of encoder neural network layers that encode identities, positions, and orientations of joints in a skeletal structure for each pose in the sequence. The machine learning model also includes a graph transformer neural network with a cross-layer attention mechanism that simultaneously performs message passing at multiple resolutions (e.g., joint level, limb level, body level, etc.) associated with the skeletal structure within a given pose and temporal relationships that link poses across the sequence of poses (e.g., based on the encoded identities, spatial and temporal positions, and orientations). The machine learning model further includes a set of decoder neural network layers that decode the final encodings outputted by the graph neural network into positions and orientations of the joints. A forward kinematics step is used to convert the positions and orientations outputted by the machine learning model into updated positions and orientations of the joints that are consistent with the lengths of bones in the skeletal structure.

One technical advantage of the disclosed techniques relative to the prior art is the ability to generate complete motions from sparse poses and joint-level constraints. The disclosed techniques thus reduce time and resource overhead associated with manually defining dense poses and/or constraints in traditional animation workflows and/or as input into conventional neural completion models. The disclosed techniques additionally provide finer-grained control over the generated motions than conventional neural completion models that require dense context and/or constraints on poses within an animation. Another technical advantage of the disclosed techniques is the ability to make select changes to certain portions of a base motion while preserving remaining portions of the base motion. Consequently, the disclosed techniques can be used in motion editing workflows, unlike conventional approaches that disregard existing motion after constraints on the motion are specified. These technical advantages provide one or more technological improvements over prior art approaches.

1. In some embodiments, a computer-implemented method for generating a motion for a virtual character comprises determining a graph representation of a plurality of sets of joints corresponding to a sequence of poses for the virtual character based on (i) one or more input poses for the virtual character and (ii) a set of constraints associated with one or more joints included in the plurality of sets of joints; generating, via execution of a first neural network, a set of updated node states for the plurality of sets of joints based on the graph representation; and generating, based on the set of updated node states, the motion that includes (i) a first set of joint positions for the plurality of sets of joints and (ii) a first set of joint orientations for the plurality of sets of joints.

2. The computer-implemented method of clause 1, further comprising training the first neural network using (i) a first loss that is computed between a subset of the first set of joint positions and a second set of joint positions included in the one or more input poses and (ii) a second loss that is computed between a subset of the first set of joint orientations and a second set of joint orientations included in the one or more input poses.

3. The computer-implemented method of any of clauses 1-2, further comprising training the first neural network based on one or more additional losses associated with the set of constraints.

4. The computer-implemented method of any of clauses 1-3, wherein the first loss is further computed based on a first set of control parameters associated with preservation of the second set of joint positions in the motion and the second loss is computed based on a second set of control parameters associated with preservation of the second set of joint orientations in the motion.

5. The computer-implemented method of any of clauses 1-4, wherein determining the graph representation comprises generating, via execution of a second neural network, a first set of embeddings associated with (i) a set of identities for the plurality of sets of joints and (ii) a temporal position of each set of joints included in the plurality of sets of joints within the sequence of poses; determining, based on the one or more input poses and the set of constraints, (i) a second set of joint positions for the plurality of sets of joints and (ii) a second set of joint orientations for the plurality of sets of joints; and converting, via execution of a third neural network, the second set of joint positions and the second set of joint orientations into a second set of embeddings for the plurality of sets of joints.

6. The computer-implemented method of any of clauses 1-5, wherein the second set of joint positions and the second set of joint orientations are further determined based on an interpolation associated with the one or more input poses and the set of constraints.

7. The computer-implemented method of any of clauses 1-6, wherein converting the graph representation into the set of updated node states comprises generating the set of updated node states based a hierarchy of resolutions associated with the graph representation and a set of message-passing iterations.

8. The computer-implemented method of any of clauses 1-7, wherein generating the motion comprises converting, via execution of one or more additional neural networks, the set of updated node states into the first set of joint positions and the first set of joint orientations; and updating the first set of joint positions and the first set of joint orientations based on a rest pose for the virtual character.

9. The computer-implemented method of any of clauses 1-8, wherein the set of constraints comprises at least one of a position constraint, an orientation constraint, or a ground contact constraint.

10. The computer-implemented method of any of clauses 1-9, wherein the first neural network comprises a set of cross-layer attention blocks associated with a plurality of resolutions for a skeletal structure of the virtual character.

11. In some embodiments, one or more non-transitory computer-readable media store instructions that, when executed by one or more processors, cause the one or more processors to perform operations comprising determining a graph representation of a plurality of sets of joints corresponding to a sequence of poses for a virtual character based on (i) one or more input poses for the virtual character and (ii) a set of constraints associated with one or more joints included in the plurality of sets of joints; generating, via execution of a first neural network, a set of updated node states for the plurality of sets of joints based on the graph representation; and generating, based on the set of updated node states, a motion that includes (i) a first set of joint positions for the plurality of sets of joints and (ii) a first set of joint orientations for the plurality of sets of joints.

12. The one or more non-transitory computer-readable media of clause 11, wherein the operations further comprise training the first neural network using (i) a first loss that is computed between a first subset of the first set of joint positions and a second set of joint positions included in a ground truth sequence of poses for the virtual character and (ii) a second loss that is computed between a first subset of the first set of joint orientations and a second set of joint orientations included in the ground truth sequence of poses.

13. The one or more non-transitory computer-readable media of any of clauses 11-12, wherein the operations further comprise further training the first neural network based on one or more additional losses associated with the one or more input poses and the set of constraints.

14. The one or more non-transitory computer-readable media of any of clauses 11-13, wherein the operations further comprise sampling the set of constraints from the ground truth sequence of poses prior to computing the one or more additional losses.

15. The one or more non-transitory computer-readable media of any of clauses 11-14, wherein the one or more additional losses comprise (i) a third loss that is computed between a second subset of the first set of joint positions and a third set of joint positions included in the one or more input poses and the set of constraints and (ii) a fourth loss that is computed between a second subset of the first set of joint orientations and a third set of joint orientations included in the one or more input poses and the set of constraints.

16. The one or more non-transitory computer-readable media of any of clauses 11-15, wherein converting the graph representation into the set of updated node states comprises computing a set of attention scores based on the graph representation; and generating the set of updated node states based on the set of attention scores.

17. The one or more non-transitory computer-readable media of any of clauses 11-16, wherein the set of attention scores is further computed based on a set of masks associated with the one or more input poses or the set of constraints.

18. The one or more non-transitory computer-readable media of any of clauses 11-17, wherein the graph representation comprises a plurality of nodes corresponding to the plurality of sets of joints, a plurality of spatial edges between a first subset of node pairs included in the plurality of nodes, and a plurality of temporal edges between a second subset of node pairs included in the plurality of nodes.

19. The one or more non-transitory computer-readable media of any of clauses 11-18, wherein the operations further comprise outputting a set of motion curves corresponding to at least a portion of the motion within a user interface; determining an update to the set of constraints based on user input associated with the set of motion curves; and generating an updated motion for the virtual character based on the update to the set of constraints, wherein the updated motion includes (i) a second set of joint positions associated with the update to the set of constraints and (ii) a second set of joint orientations associated with the update to the set of constraints.

20. In some embodiments, a system comprises one or more memories that store instructions, and one or more processors that are coupled to the one or more memories and, when executing the instructions, are configured to perform operations comprising determining graph representation of a plurality of sets of joints corresponding to a sequence of poses for a virtual character based on (i) a starting input pose for the virtual character and (ii) and ending input pose for the virtual character; generating, via execution of a first neural network, a set of updated node states for the plurality of sets of joints based on the graph representation; and generating, based on the set of updated node states, a motion that includes (i) a first set of joint positions for the plurality of sets of joints and (ii) a first set of joint orientations for the plurality of sets of joints.

21. In some embodiments, a computer-implemented method for generating a motion for a virtual character comprises determining a graph representation of a plurality of sets of joints corresponding to a sequence of poses for the virtual character based on (i) a base motion associated with the sequence of poses and (ii) a set of constraints associated with one or more joints included in the plurality of sets of joints; generating, via execution of a first neural network, a set of updated node states for the plurality of sets of joints based on the graph representation; and generating, based on the set of updated node states, the motion that includes (i) a first set of joint positions for the plurality of sets of joints and (ii) a first set of joint orientations for the plurality of sets of joints.

22. The computer-implemented method of clause 21, further comprising training the first neural network using (i) a first loss that is computed between a subset of the first set of joint positions and a second set of joint positions included in the base motion and (ii) a second loss that is computed between a subset of the first set of joint orientations and a second set of joint orientations included in the base motion.

23. The computer-implemented method of any of clauses 21-22, further comprising training the first neural network based on one or more additional losses associated with the set of constraints.

24. The computer-implemented method of any of clauses 21-23, wherein at least one of the first loss or the second loss comprise a weight mask that is applied to a subset of the plurality of sets of joints based on a temporal proximity to the set of constraints.

25. The computer-implemented method of any of clauses 21-24, further comprising training the first neural network using a reconstruction loss that is computed between the motion and a ground truth motion associated with the sequence of poses.

26. The computer-implemented method of any of clauses 21-25, further comprising sampling an additional set of constraints from the ground truth motion; and generating, via execution of a second neural network, the base motion based on the additional set of constraints.

27. The computer-implemented method of any of clauses 21-26, wherein determining the graph representation comprises generating, via execution of a second neural network, a first set of embeddings associated with (i) a set of identities for the plurality of sets of joints and (ii) a temporal position of each set of joints included in the plurality of sets of joints within the sequence of poses; determining, based on the base motion and the set of constraints, (i) a second set of joint positions for the plurality of sets of joints and (ii) a second set of joint orientations for the plurality of sets of joints; and converting, via execution of a third neural network, the second set of joint positions and the second set of joint orientations into a second set of embeddings for the plurality of sets of joints.

28. The computer-implemented method of any of clauses 21-27, wherein determining the graph representation comprises initializing (i) a second set of joint positions for the plurality of sets of joints and (ii) a second set of joint orientations for the plurality of sets of joints using the base motion.

29. The computer-implemented method of any of clauses 21-28, wherein generating the motion comprises converting, via execution of one or more additional neural networks, the set of updated node states into the first set of joint positions and the first set of joint orientations; and updating the first set of joint positions and the first set of joint orientations based on a rest pose for the virtual character.

30. The computer-implemented method of any of clauses 21-29, wherein the set of constraints comprises at least one of a position constraint, an orientation constraint, or a ground contact constraint.

31. In some embodiments, one or more non-transitory computer-readable media store instructions that, when executed by one or more processors, cause the one or more processors to perform operations comprising determining a graph representation of a plurality of sets of joints corresponding to a sequence of poses for a virtual character based on (i) a base motion associated with the sequence of poses and (ii) a set of constraints associated with one or more joints included in the plurality of sets of joints; generating, via execution of a first neural network, a set of updated node states for the plurality of sets of joints based on the graph representation; and generating, based on the set of updated node states, a motion that includes (i) a first set of joint positions for the plurality of sets of joints and (ii) a first set of joint orientations for the plurality of sets of joints.

32. The one or more non-transitory computer-readable media of clause 31, wherein the operations further comprise training the first neural network using (i) a first loss associated with the base motion and (ii) a second loss associated with the set of constraints.

33. The one or more non-transitory computer-readable media of any of clauses 31-32, wherein the first loss comprises a weight mask that is applied to a subset of the plurality of sets of joints based on a temporal proximity to the set of constraints.

34. The one or more non-transitory computer-readable media of any of clauses 31-33, wherein the first loss is scaled by a control parameter associated with preservation of a second set of joint positions and a second set of joint orientations from the base motion in the motion.

35. The one or more non-transitory computer-readable media of any of clauses 31-34, wherein the operations further comprise training the first neural network using a reconstruction loss that is computed between the motion and a ground truth motion associated with the sequence of poses.

36. The one or more non-transitory computer-readable media of any of clauses 31-35, wherein the operations further comprise sampling an additional set of constraints from the ground truth motion; and generating, via execution of a second neural network, the base motion based on the additional set of constraints.

37. The one or more non-transitory computer-readable media of any of clauses 31-36, wherein converting the graph representation into the set of updated node states comprises computing a set of attention scores based on the graph representation; and generating the set of updated node states based on the set of attention scores.

38. The one or more non-transitory computer-readable media of any of clauses 31-37, wherein the operations further comprise outputting a set of motion curves corresponding to at least a portion of the motion within a user interface; determining an update to the set of constraints based on user input associated with the set of motion curves; and generating an updated motion for the virtual character based on the update to the set of constraints, wherein the updated motion includes (i) a second set of joint positions associated with the update to the set of constraints and (ii) a second set of joint orientations associated with the update to the set of constraints.

39. The one or more non-transitory computer-readable media of any of clauses 31-38, wherein the graph representation comprises a plurality of nodes corresponding to the plurality of sets of joints, a plurality of spatial edges between a first subset of node pairs included in the plurality of nodes, and a plurality of temporal edges between a second subset of node pairs included in the plurality of nodes.

40. In some embodiments, a system comprises one or more memories that store instructions, and one or more processors that are coupled to the one or more memories and, when executing the instructions, are configured to perform the steps of determining a graph representation of a plurality of sets of joints corresponding to a sequence of poses for a virtual character based on (i) a base motion associated with the sequence of poses and (ii) a set of constraints associated with one or more joints included in the plurality of sets of joints; generating, via execution of a first neural network, a set of updated node states for the plurality of sets of joints based on the graph representation; and generating, based on the set of updated node states, a motion that includes (i) a first set of joint positions for the plurality of sets of joints and (ii) a first set of joint orientations for the plurality of sets of joints.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a motion for a virtual character, comprising:
determining a graph representation of a plurality of sets of joints corresponding to a sequence of poses for the virtual character based on (i) one or more input poses for the virtual character and (ii) a set of constraints associated with one or more joints included in the plurality of sets of joints;
generating, via execution of a first neural network, a set of updated node states for the plurality of sets of joints based on the graph representation; and
generating, based on the set of updated node states, the motion that includes (i) a first set of joint positions for the plurality of sets of joints and (ii) a first set of joint orientations for the plurality of sets of joints.

2. The computer-implemented method of claim 1, further comprising training the first neural network using (i) a first loss that is computed between a subset of the first set of joint positions and a second set of joint positions included in the one or more input poses and (ii) a second loss that is computed between a subset of the first set of joint orientations and a second set of joint orientations included in the one or more input poses.

3. The computer-implemented method of claim 2, further comprising training the first neural network based on one or more additional losses associated with the set of constraints.

4. The computer-implemented method of claim 2, wherein the first loss is further computed based on a first set of control parameters associated with preservation of the second set of joint positions in the motion and the second loss is computed based on a second set of control parameters associated with preservation of the second set of joint orientations in the motion.

5. The computer-implemented method of claim 1, wherein determining the graph representation comprises:
generating, via execution of a second neural network, a first set of embeddings associated with (i) a set of identities for the plurality of sets of joints and (ii) a temporal position of each set of joints included in the plurality of sets of joints within the sequence of poses;
determining, based on the one or more input poses and the set of constraints, (i) a second set of joint positions for the plurality of sets of joints and (ii) a second set of joint orientations for the plurality of sets of joints; and
converting, via execution of a third neural network, the second set of joint positions and the second set of joint orientations into a second set of embeddings for the plurality of sets of joints.

6. The computer-implemented method of claim 5, wherein the second set of joint positions and the second set of joint orientations are further determined based on an interpolation associated with the one or more input poses and the set of constraints.

7. The computer-implemented method of claim 1, wherein converting the graph representation into the set of updated node states comprises generating the set of updated node states based a hierarchy of resolutions associated with the graph representation and a set of message-passing iterations.

8. The computer-implemented method of claim 1, wherein generating the motion comprises:
converting, via execution of one or more additional neural networks, the set of updated node states into the first set of joint positions and the first set of joint orientations; and
updating the first set of joint positions and the first set of joint orientations based on a rest pose for the virtual character.

9. The computer-implemented method of claim 1, wherein the set of constraints comprises at least one of a position constraint, an orientation constraint, or a ground contact constraint.

10. The computer-implemented method of claim 1, wherein the first neural network comprises a set of cross-layer attention blocks associated with a plurality of resolutions for a skeletal structure of the virtual character.

11. One or more non-transitory computer-readable media storing instructions that, when executed by one or more processors, cause the one or more processors to perform operations comprising:
determining a graph representation of a plurality of sets of joints corresponding to a sequence of poses for a virtual character based on (i) one or more input poses for the virtual character and (ii) a set of constraints associated with one or more joints included in the plurality of sets of joints;
generating, via execution of a first neural network, a set of updated node states for the plurality of sets of joints based on the graph representation; and
generating, based on the set of updated node states, a motion that includes (i) a first set of joint positions for the plurality of sets of joints and (ii) a first set of joint orientations for the plurality of sets of joints.

12. The one or more non-transitory computer-readable media of claim 11, wherein the operations further comprise training the first neural network using (i) a first loss that is computed between a first subset of the first set of joint positions and a second set of joint positions included in a ground truth sequence of poses for the virtual character and (ii) a second loss that is computed between a first subset of the first set of joint orientations and a second set of joint orientations included in the ground truth sequence of poses.

13. The one or more non-transitory computer-readable media of claim 12, wherein the operations further comprise further training the first neural network based on one or more additional losses associated with the one or more input poses and the set of constraints.

14. The one or more non-transitory computer-readable media of claim 13, wherein the operations further comprise sampling the set of constraints from the ground truth sequence of poses prior to computing the one or more additional losses.

15. The one or more non-transitory computer-readable media of claim 13, wherein the one or more additional losses comprise (i) a third loss that is computed between a second subset of the first set of joint positions and a third set of joint positions included in the one or more input poses and the set of constraints and (ii) a fourth loss that is computed between a second subset of the first set of joint orientations and a third set of joint orientations included in the one or more input poses and the set of constraints.

16. The one or more non-transitory computer-readable media of claim 11, wherein converting the graph representation into the set of updated node states comprises:
computing a set of attention scores based on the graph representation; and
generating the set of updated node states based on the set of attention scores.

17. The one or more non-transitory computer-readable media of claim 16, wherein the set of attention scores is further computed based on a set of masks associated with the one or more input poses or the set of constraints.

18. The one or more non-transitory computer-readable media of claim 11, wherein the graph representation comprises a plurality of nodes corresponding to the plurality of sets of joints, a plurality of spatial edges between a first subset of node pairs included in the plurality of nodes, and a plurality of temporal edges between a second subset of node pairs included in the plurality of nodes.

19. The one or more non-transitory computer-readable media of claim 11, wherein the operations further comprise:
outputting a set of motion curves corresponding to at least a portion of the motion within a user interface;
determining an update to the set of constraints based on user input associated with the set of motion curves; and
generating an updated motion for the virtual character based on the update to the set of constraints, wherein the updated motion includes (i) a second set of joint positions associated with the update to the set of constraints and (ii) a second set of joint orientations associated with the update to the set of constraints.

20. A system, comprising:
one or more memories that store instructions, and
one or more processors that are coupled to the one or more memories and, when executing the instructions, are configured to perform operations comprising:
determining graph representation of a plurality of sets of joints corresponding to a sequence of poses for a virtual character based on (i) a starting input pose for the virtual character and (ii) and ending input pose for the virtual character;
generating, via execution of a first neural network, a set of updated node states for the plurality of sets of joints based on the graph representation; and
generating, based on the set of updated node states, a motion that includes (i) a first set of joint positions for the plurality of sets of joints and (ii) a first set of joint orientations for the plurality of sets of joints.
